(19) United States
(12) Patent Application Publication
(10) Pub. No.: US 2005/0273344 A1
(43) Pub. Date: Dec. 8, 2005

(54) Domain name maintenance

(76) Inventors: Vincent M. Lee, Ashburn, VA (US); Rohit Kinra, Germantown, MD (US)

Correspondence Address: KENYON & KENYON, 1500 K STREET NW, SUITE 700, WASHINGTON, DC, 20005, US

(21) Appl. No.: 10/857,842

(22) Filed: Jun. 2, 2004

(51) Int. Cl. G06F 17/60

(52) U.S. Cl. 705/1

(57) ABSTRACT

A request from a user is received to maintain the registration of a domain name for a maintenance term that is longer than the maximum term accepted by the appropriate registry in a single registration or renewal request, along with an up front payment for the cost of the entire maintenance term. The expiration date of the registration record at the registry is set to the maximum term, and is subsequently reset until the total term of the registration is at least equal to the requested maintenance term.

### FIELD OF THE INVENTION

The field of the invention is domain names, and in particular, maintaining a domain name registration.

### BACKGROUND OF THE INVENTION

A known system for domain name registration is shown in FIG. 1. A plurality of registrars 101, 102, 103 and 104 are coupled to a single registry 105 (e.g., through a network such as the Internet) that is responsible for maintaining registration records for all domain names having a given Top Level Domain (TLD), such as .com and net. Users 106 send requests through a network 107 (such as the Internet) to registrars (e.g., 101) to register a domain name or maintain an existing domain name registration, which is stored at the registry 105.

Each registration record at the registry has a registration expiration date. Unless the registration is renewed by the registration date (or, in some cases, during a grace period following the expiration date), the domain name will become generally available for registration after the expiration date. In certain known systems, a registry accepts no longer than a given maximum term for a registration in a registration request or a renewal request. Although the expiration date of a registration can be extended in subsequent requests, the total registration term listed in a registration record may not exceed the maximum accepted term. For example, a registry may accept a maximum term of ten years in a registration or renewal request. Although the registration can be renewed an unlimited number of times, the remaining term in the registration record can never be more than ten years.

An example of the flow of messages in this system is shown in FIG. 2. A registrar receives a request from a user to register a domain name of the user's choosing. The registrar determines if the requested domain name is available, e.g., not already registered by another. If it is unavailable, the registrar sends a message to the user rejecting the request. If it is available, the registrar collects registration information (e.g., ownership, contact information, etc.) and a payment from the user, and sends at least some of this information to the registry with a request to register the domain name. A payment is also made by the registrar to the registry. The amount of the payment is typically related to the term for which the domain name is registered at the registry. The registry adds a record to its domain name database, thereby establishing the registration.

It is known for a registrar to charge a user a fee based upon the user's requested duration of the registration. Likewise, the registry charges to the registrar a fee based upon the time period for which the registration is created or renewed at the registry. The registry fee to the registrar is typically less than the registrar fee to the user. For example, a registrar may charge a user $35 per year for registering and maintaining a domain name registration, and the registry may charge the registrar $6 per year for the same.

Services are known for automatically renewing domain name registrations where the service sends a notification to a user regarding the upcoming expiration of a domain name. If the user indicates that a renewal is desired, the service charges the user for a renewal term and renews the registration.

Automatic renewal services are known in which the service automatically charges the user and renews the registration at or around the expiration date. An example of such a system is shown in FIG. 3. At or about each expiration date, the user's account is charged and the registration is renewed for another given period.

In some cases, an automatic renewal service fails because the payment information provided by a user becomes invalid. For example, a credit card provided by the user to the registrar to automatically charge for renewals expires, or else is canceled. In this case, the renewal service can attempt to contact the user for updated payment information. However, sometimes this is impossible. For example, the person who established the renewal service could have been an employee of a company in whose name the domain name is registered, and the person could have left the company. The person's contact information could be invalid. At this point, substantial investigation could be necessary to find an alternative contact to whom to send an inquiry to obtain updated payment information, or even to determine if the company is still interested in having the registration renewed. Such investigation is typically beyond the capability of a renewal service. Without a valid payment instrument of the registrant, the domain name registration can be allowed to lapse. In this way, valuable and important domain names can be inadvertently permitted to lapse.

In some other cases, automatic renewal services can fail when the company providing the service goes out of business. This can occur when the renewal service waits until the registration is about to expire before renewing it at the registrar.

### BRIEF DESCRIPTION OF THE DRAWINGS

FIG. 1 shows a prior art architecture of a domain name registration system.

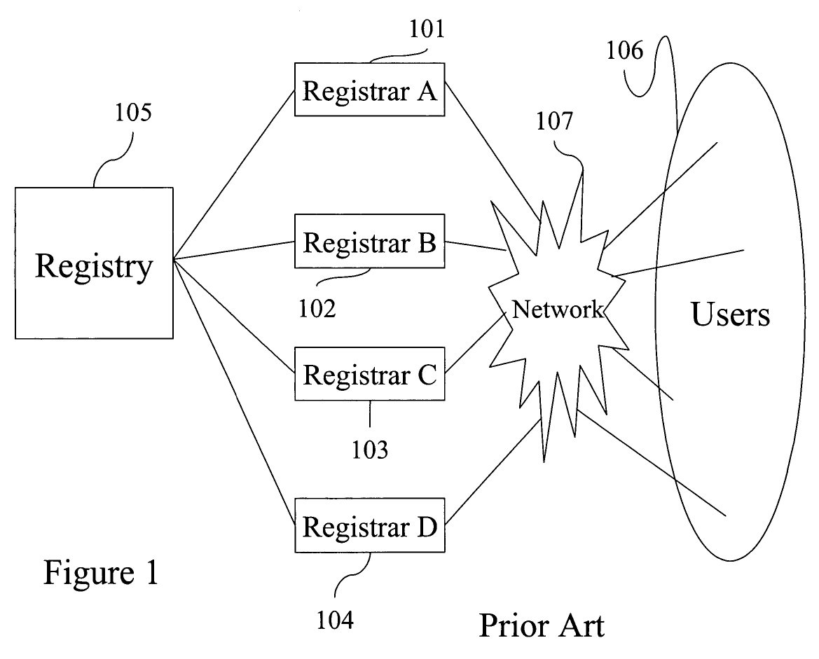

FIG. 2 is a prior art message flow diagram from domain name registration.

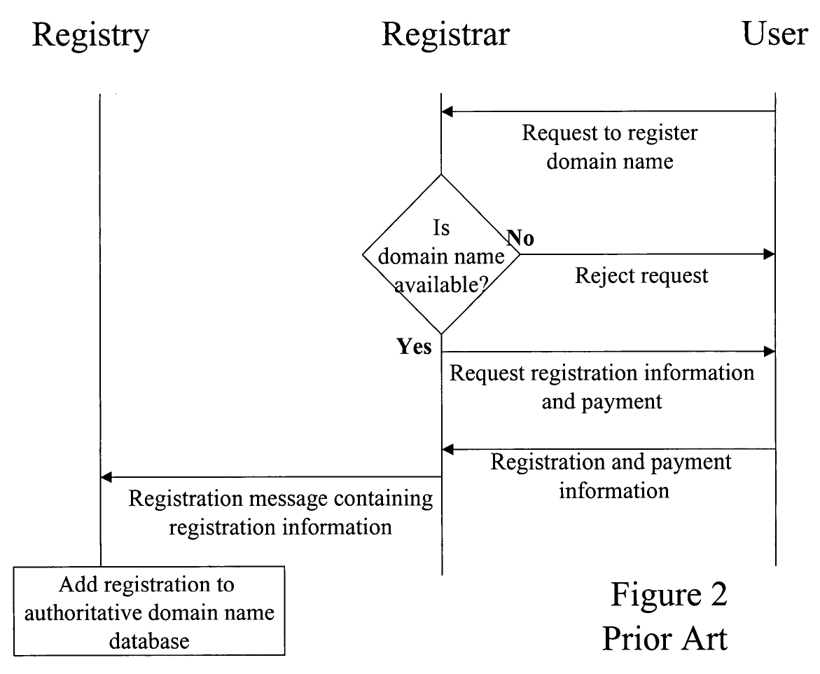

FIG. 3 shows a prior art timeline for an automatic renewal service.

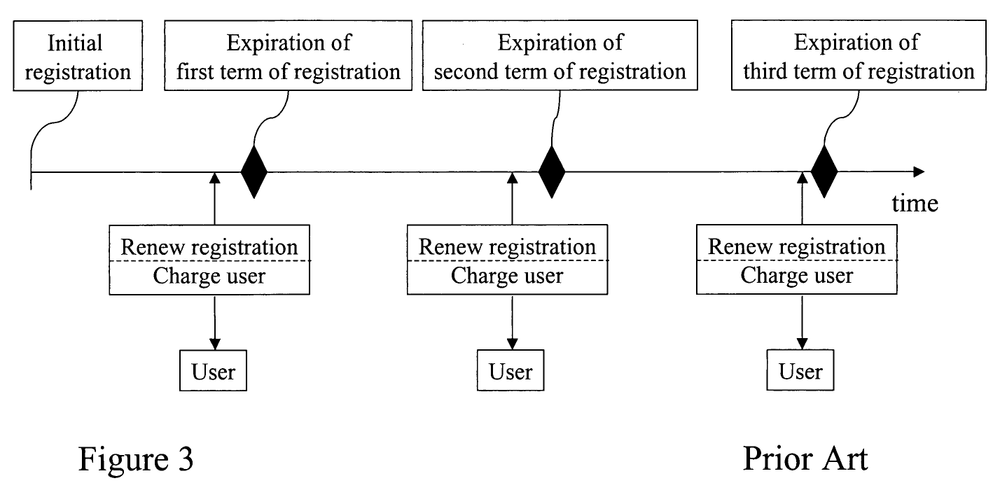

FIG. 4 shows a timeline in accordance with an embodiment of the present invention.

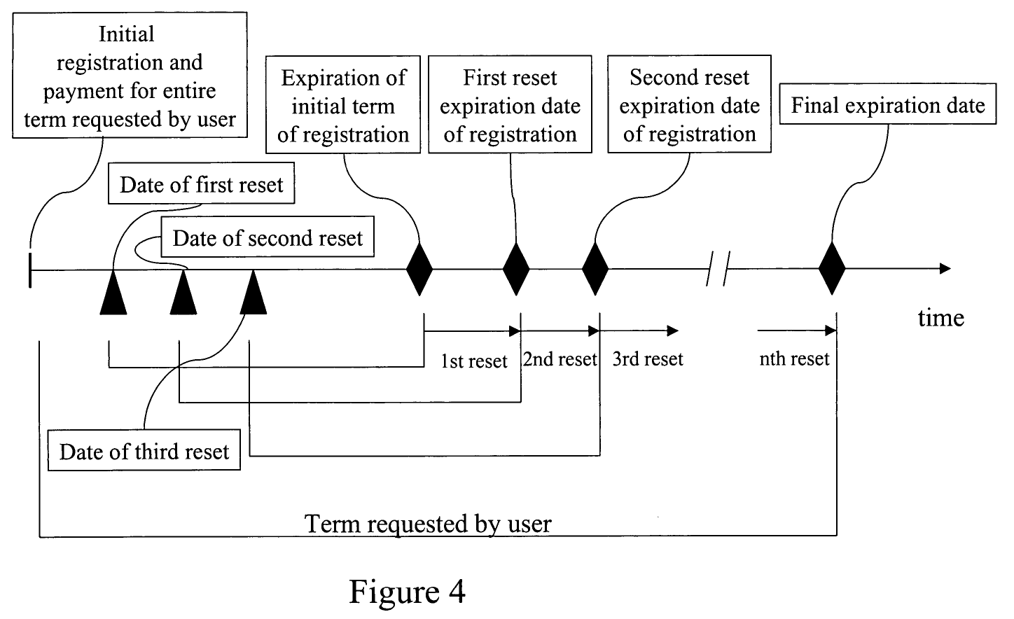

FIG. 5 shows the term of a domain name registration in a registration record at a registry that accepts at most a three year registration term, where the user has requested a seven year maintenance term.

FIG. 6 shows an apparatus in accordance with an embodiment of the present invention.

### DETAILED DESCRIPTION

In an embodiment of the present invention, a service can receive a request from a user to register a domain name, and to maintain the registration for a period of time that exceeds the maximum time period accepted by the appropriate registry in a single registration request. A service can be a registrar. For example, the user may request that the registrar maintain the registration for 50 years following the date of the initial registration, but the registry may register domain names for no more than ten years at a time.

If the domain name is available, the service can accept a single, up front payment for the entire term requested by the user, and then register the domain name for the maximum period possible at the registry. Thus, in the foregoing example, the registrar can send a message to the registry to register the domain name for a period of ten years. As time passes, the service can maintain the registration without any further charge to the user by sending a message to the registry to reset the registration's expiration date, e.g., to the maximum term allowable by the registry. This can occur at any time during the pendency of the registration at the registry, or during a grace period after the domain name registration expiration date, if permitted by the registry. Any fee charged by the registry to the registrar for resetting the expiration date can be paid by the registrar. The customer need not be charged.

For example, a representative of a company (a user) sends a request to a registrar to register the domain name ACME.COM and to maintain the registration for a period of 70 years. Suppose the registrar charges a user $35 per year to maintain a registration, and the registry charges the registrar $6 per year. The maximum term accepted by the present registry for the COM TLD is ten years. If ACME.COM is determined by the registrar to be available for registration, the registrar accepts an up front, lump some payment for the entire requested term from the user to the sum of $35/year×70 years=$2450. This is only an example of such a fee calculation, and any other suitable fee arrangement is encompassed within the scope of the present invention. For example, the registrar may offer a 10% discount for maintenance terms between 10 and 20 years; 20% for terms between 20 and 50 years; a 30% discount for terms over 50 years; etc.

Upon receiving payment, the registrar can send a message to the registry to register the domain name for the maximum period accepted by the registry, which in this example is 10 years. As time passes, the registrar can send a message to the registry to reset the expiration date of the registration once again to the maximum accepted by the registry. For example, at the one year anniversary of the registration, the registrar can send a message to the registry to reset the expiration date of the registration to a date one year later than the original expiration date. The registry can then charge the registrar $6 for the extra year of registration term, which the registrar can pay. However, no new charges accrue to the user, as the registrar collected all of the money for the entire term up front from the user.

The frequency and timing of the registration expiration date reset messages from the registrar to the registry can occur in any suitable arrangement. For example, suppose the registry accepts extension messages only at or about the annual anniversary of the original expiration date. The registrar can send a reset message on each anniversary. In another situation, the registry may charge a flat per-update fee for resetting the expiration date as well as a fee related to the length of time for which the expiration date is extended. In this case, the registry may wish to limit the number of times it sends a reset message, e.g., sending it only once, such as on the date that is one year before the present expiration date of the registration. In yet another example, the registry may have a flexible, sliding scale of charges based upon the number of days for which the registration is extended by resetting the expiration date. In this case, the registrar may wish to send a reset message on dates and at a frequency of its own convenience, e.g., on the third Thursday of September, one year before the current date of expiration of the registration, once a month, etc. Frequent renewals could show to anyone periodically accessing the registration information (e.g., via whois queries) that the owner is subscribed to a renewal service in accordance with an embodiment of the present invention, because, for example, the expiration date shown for the registration would never be less than one or two years than the maximum term accepted by the registry, until the end of the user's requested term is reached.

In accordance with an embodiment of the present invention, the registrar can send a reset message to the registry to reset the expiration date of the registration to the maximum accepted by the registry until the time period remaining on the user's requested term is less than the maximum term accepted. At that time, the registrar need not send further reset messages. For example, if the maximum term accepted by the registry is five years, and if the user's requested maintenance term is forty years, then the registrar can send an annual message to the registry on the anniversary of the registration to reset the expiration date to the maximum accepted term. The registrar can stop sending reset messages in year 40 of the requested term. The term of the registration will run down to zero (i.e., the registration will expire) at the time the requested maintenance term ends.

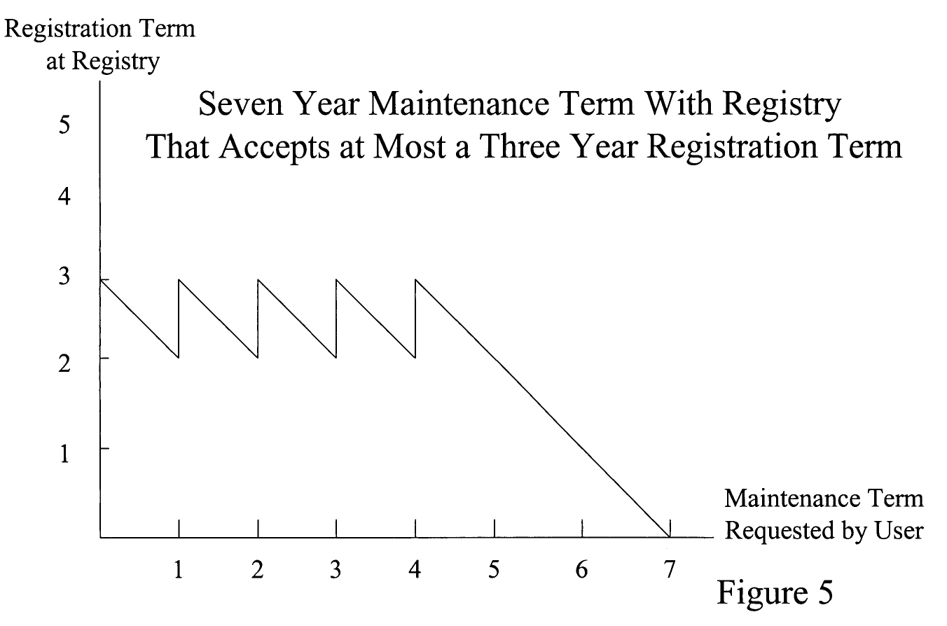

FIG. 5 shows the remaining time until the expiration date of a registration as it is stored in a registration record at a registry, where the maximum term accepted by the registry in a registration request (or registration renewal request) is three years, and the maintenance term requested by a user is seven years. The registrar initially registers the domain name for the maximum term accepted by the registry (three years), accepts payment for the entire seven year maintenance term from the user, and then automatically sends a message to the registry to reset the expiration term to the maximum three years in years 1-4 of the maintenance term. Thereafter, the registration is term is allowed to run until expiration at end of the requested seven year maintenance term.

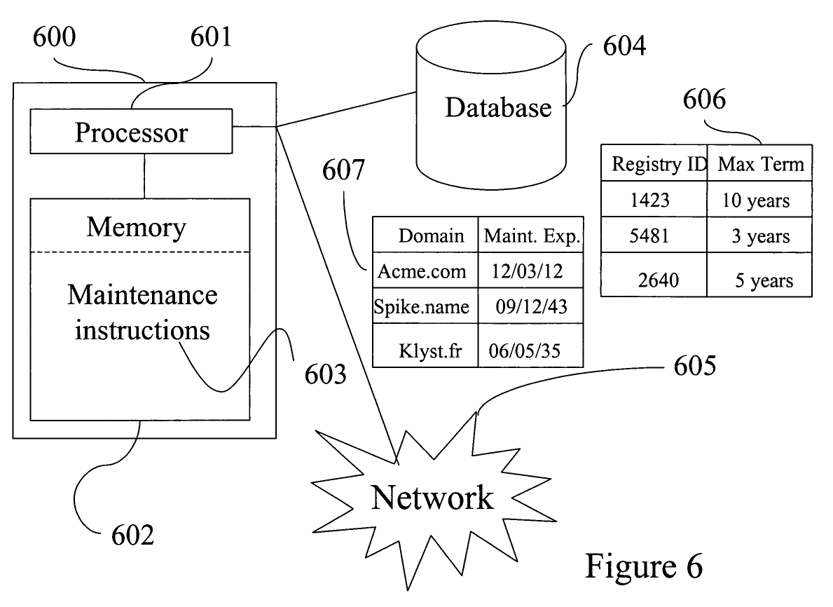

FIG. 6 shows an apparatus 600 in accordance with an embodiment of the present invention. A processor 601 is coupled to memory 602 that stores maintenance instructions 603 that are adapted to be executed by processor 601 to perform at least part of the method in accordance with the present invention. For example, maintenance instructions 603 can be executed by processor 601 to receive a request from a user to register or renew a domain name registration for a certain maintenance term, receive payment information from the user and charge a user payment instrument (e.g., a credit card, a debit account, etc.) a single time for the entire cost of maintaining the domain name registration for the requested maintenance term and send an appropriate message to the registry. If the request is to register a domain name, the maintenance instructions 603 can be executed by processor 601 to register the domain name for the maximum term accepted by the registry in a registration request, and then send a message to the registry to reset the expiration date in the registration to a later date, until the expiration of the maintenance term. Instructions 603 can also be executed by processor 601 to send a message authorizing payment to the appropriate registry for registering the domain name or for resetting the expiration date in an existing registration.

Processor 601 can be a general purpose microprocessor, such as the Intel Pentium 4 processor, manufactured by the Intel Corporation of Santa Clara, Calif. Processor 601 can be an Application Specific Integrated Circuit (ASIC) that embodies at least part of the method of the present invention in its firmware and hardware. An example of an ASIC is a Digital Signal Processor (DSP.)

Memory 602 can be any device that can electronically store information, such as Random Access Memory (RAM), Read Only Memory (ROM), flash memory, a hard disk, a CD-ROM, etc.

Instructions that are adapted to be executed on a processor to embody the method in accordance with an embodiment of the present invention can be stored on a medium such as a memory device (where the definition of “memory device” is the same as for memory 602, above), or in a telecommunications channel. For example, the instructions can be downloaded from a server to a client over a telecommunications channel through a network, such as the Internet using unicast or multicast techniques, from a wireless transmitter over a telecommunications channel to a wired network to a recipient, etc.

Processor 601 can be coupled to a database 604 that stores information that can be used in accordance with an embodiment of the present invention. Database 604 can be any kind of suitable database, such as a relational database, a multidimensional database (cube), etc. Database 604 can be part of apparatus 600, or can be coupled to apparatus 600 directly or through a Local Area Network (such as an Ethernet), a Wide Area Network (WAN), the Internet 605, etc. Database 604 can store a tables such as a table 606 relating a registry identifier to the maximum term accepted by the registrar in a single registration or renewal request. In formulating the expiration reset message, apparatus 600 can look up the maximum term accepted by the registry to which the message is to be sent, and calculate the latest date to which a registration may be reset. This date (or an earlier date) can be included in the expiration date reset message. Each registry identifier can correspond to one registry. More than one code can correspond to a single registry. For example, registry identifier 1423 can correspond to the registry for the COM TLD; 5481 can correspond to the NAME TLD registry; and 2640 can correspond to the FR TLD. Another identifier (say, 3861) can correspond to the NET registry, even though the COM and NET TLDs can both be managed by the same registry.

Database 605 can also store a table 607 that includes records that relate a domain name to a maintenance term. This information can be used along with the current date by apparatus 600 to determine if an expiration date reset message should be sent to the appropriate registry. It can also be used, along with the information in table 606, to select a date to which to reset the expiration date of the registration in a message to the registry, as described above. Table 607 shows that the domain name Acme.com has a maintenance term that expires on Dec. 3, 2012. Thus, the registration expiration date for Acme.com at the registry responsible for the COM TLD should be extended until that date. This can be done by sending one or more expiration date reset messages from apparatus 600 to the registry.

Apparatus 600 can communicate with users and registries (not shown) through network 605, which can be, for example, the Internet.

One of ordinary skill in the art will recognize that the above description is meant to illustrate and not exhaustively describe all of the features of the present invention. Other features will be apparent to those of skill in the art upon reading the description and seeing the figures.

1. A method for managing domain name registration, including:
receiving at a registrar a request from a user to register or extend an existing registration for a domain name at a domain name registry for a requested maintenance term;
receiving at the registrar a single payment for maintaining the registration of the domain name for the requested maintenance term;
if the request from the user is to create a new registration for the domain name, then sending a message to the registry that causes the registry to register the domain name for the maximum term accepted by the registry for a domain name registration, said registry registration having an expiration date, and sending at least one subsequent message from the registrar to the registry that causes the expiration date of the domain name registration at the registry to be reset to a later date, at least until the requested maintenance term for the registration is attained; and
if the request is to extend an existing registration, then sending at least one message from the registrar to the registry that causes the expiration date of the domain name registration at the registry to be reset to a later date, at least until the requested maintenance term for the registration is attained.

2. The method of claim 1, wherein at least two messages from the registrar to the registry to reset the expiration date of the registration are sent prior to the initial expiration date of the registration.

3. The method of claim 1, wherein the message from the registrar to the registry to reset the expiration date of the registration is to reset the expiration date of the registration to the maximum term accepted by the registry in a registration request.

4. An apparatus for managing domain name registration, including:
a processor;
a memory coupled to said processor, said memory storing maintenance instructions adapted to be executed by said processor to perform steps including:
receiving at a registrar a request from a user to register or extend an existing registration for a domain name at a domain name registry for a requested maintenance term;
receiving at the registrar a single payment for maintaining the registration of the domain name for the requested maintenance term;
if the request from the user is to create a new registration for the domain name, then sending a message to the registry that causes the registry to register the domain name for the maximum term accepted by the registry for a domain name registration, said registry registration having an expiration date, and sending at least one subsequent message from the registrar to the registry that causes the expiration date of the domain name registration at the registry to be reset to a later date, at least until the requested maintenance term for the registration is attained; and
if the request is to extend an existing registration, then sending at least one message from the registrar to the registry that causes the expiration date of the domain name registration at the registry to be reset to a later date, at least until the requested maintenance term for the registration is attained.

5. The apparatus of claim 4, wherein said maintenance instructions are adapted to be executed by said processor to send at least two messages from the registrar to the registry to reset the expiration date of the registration prior to the initial expiration date of the registration.

6. The apparatus of claim 4, wherein said maintenance instructions are adapted to be executed by said processor to send a message from the registrar to the registry to reset the expiration date of the registration to the maximum term accepted by the registry in a registration request.

7. A medium storing instructions adapted to be executed by a processor to perform steps including:
receiving at a registrar a request from a user to register or extend an existing registration for a domain name at a domain name registry for a requested maintenance term;
receiving at the registrar a single payment for maintaining the registration of the domain name for the requested maintenance term;
if the request from the user is to create a new registration for the domain name, then sending a message to the registry that causes the registry to register the domain name for the maximum term accepted by the registry for a domain name registration, said registry registration having an expiration date, and sending at least one subsequent message from the registrar to the registry that causes the expiration date of the domain name registration at the registry to be reset to a later date, at least until the requested maintenance term for the registration is attained; and
if the request is to extend an existing registration, then sending at least one message from the registrar to the registry that causes the expiration date of the domain name registration at the registry to be reset to a later date, at least until the requested maintenance term for the registration is attained.

8. The medium of claim 7, wherein said instructions are adapted to be executed by the processor to send at least two messages from the registrar to the registry to reset the expiration date of the registration prior to the initial expiration date of the registration.

9. The medium of claim 7, wherein said instructions are adapted to be executed by the processor to send a message from the registrar to the registry to reset the expiration date of the registration to the maximum term accepted by the registry in a registration request.

10. A system for managing domain name registration, including:
means for receiving at a registrar a request from a user to register or extend an existing registration for a domain name at a domain name registry for a requested maintenance term;
means for receiving at the registrar a single payment for maintaining the registration of the domain name for the requested maintenance term;
means for sending a message to the registry that causes the registry to register the domain name for the maximum term accepted by the registry for a domain name registration, said registry registration having an expiration date, and for sending at least one subsequent message from the registrar to the registry that causes the expiration date of the domain name registration at the registry to be reset to a later date, at least until the requested maintenance term for the registration is attained.
